(19) United States
(12) Patent Application Publication
(10) Pub. No.: US 2007/0093673 A1
(43) Pub. Date: Apr. 26, 2007

(54) Boron-containing compounds, uses and preparation thereof

(76) Inventor: Andre Vachereau, Roxboro (CA)

Correspondence Address: BERESKIN AND PARR, 40 KING STREET WEST, BOX 401, TORONTO, ON, M5H 3Y2, CA

(21) Appl. No.: 11/255,929

(22) Filed: Oct. 24, 2005

(51) Int. Cl. C07F 5/04

(52) U.S. Cl. 558/292

(57) ABSTRACT

There are provided compounds of formula (I): 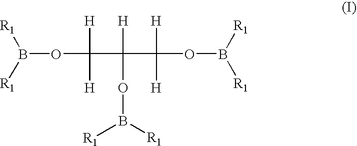
wherein R₁ is H, a C₁-C₁₂ alkyl, a C₂-C₁₂ alkenyl, a C₂-C₁₂ alkynyl, a C₃-C₈ cycloalkyl, a C₃-C₈ cycloalkenyl, a C₆-C₁₂ aryl, a C₁-C₁₂ heteroaryl group, —OR₂, or each R₁ of a same boron atom are connected together so as to form a 4 to 6 membered ring; and R₂ is H, a C₁-C₁₂ alkyl, a C₂-C₁₂ alkenyl, a C₂-C₁₂ alkynyl, a C₃-C₈ cycloalkyl, a C₃-C₈ cycloalkenyl, a C₆-C₁₂ aryl, a C₁-C₁₂ heteroaryl or each R₂ of a same boron atom are connected together so as to form a 4 to 6 membered ring. The R₁ and R₂ groups can be unsubstituted or substituted with various substituents when possible. Such compounds are particularly useful for treating inflammation and/or pain.

### FIELD OF THE INVENTION

The present invention relates to the field of medicinal chemistry. In particular, it relates to boron-containing compounds. These compounds can be used for various purposes such as anti-inflammatory agents and/or analgesic agents for the treatment of musculo-skeletal disorders and other conditions involving pain.

### BACKGROUND OF THE INVENTION

Musculo-skeletal diagnoses include the two most common forms of arthritis, osteoarthritis and rheumatoid arthritis, muscular low back pain and muscular neck pain and fibromyalgia. Injuries affecting the musculo-skeletal system which includes the bones, joints, muscles, tendons and ligaments are also included. For patients with “arthritis/rheumatism” and related conditions, the use of medications commonly prescribed for these conditions are grouped as following: (1) Non-steroidal anti-inflammatory drugs (NSAIDs), (2) Corticosteroids, (3) Disease-modifying anti-rheumatic drugs (DMARDs) and (4) Biologic response modifiers (biologics).

(1) Non-Steroidal Anti-Inflammatory Drugs (NSAIDs)

There are two classes of NSAIDs: (a) conventional or non-selective ones, such as acetylsalicylic acid (Aspirin®), acetaminophen (Tylenol®, Tempra®)), ibuprofen (Motrin®, Advil®), ketoprofen (Orudis®), naproxen (Naprosyn®, Aleve®), and diclofenac (Voltaren®). (b) The COX-2 inhibitor or selective ones, such as rofecoxib (Vioxx®), celecoxib (Celebrex®) and valdecoxib (Bextra®).

Conventional NSAIDs drugs are widely used by a variety of patients that can access the products either by prescriptions (examples: naproxen, diclofenac) or as OTC drugs (examples: acetylsalicylic acid, acetaminophen, ibuprofen). Although their effectiveness has been proved in acute pain syndromes that are inflammatory, their efficacy in controlling chronic pain is not well established. Also all these NSAIDs reach a limit to their maximum analgesics effect, even taken at “grams level”. The major drawback in the utilization of traditional NSAIDs are associated with serious drug adverse effects that very often they are worse that the illness for which the drug was prescribed. The major risk with such NSAIDs is related to a specific gastrointestinal (GI) adverse effect that causes GI bleeding and causes an estimated 16,500 deaths each year in the United States alone. Also ibuprofen, naproxen and ketoprofen were considered by FDA (last February 2005) as product that could increase risk of CV events and asked all manufacturers of such products to change label to better inform consumers regarding the safe use of these products. Although acetaminophen (Tylenol®, Tempra®) do not cause the characteristic GI side effects of NSAIDs, an overdosage can cause serious and fatal hepatic complications even in patients with no underlying liver problems. COX-2 inhibitor drugs are recent NSAIDs products that selectively block the cyclooxygenase isoform 2 (COX-2) but not the isoform 1 (COX-1), associated with the GI safety problems encountered by most conventional NSAIDs drugs. Therefore COX-2 inhibitor medications were expected as effective as other NSAIDs but without known side effects. However these breakthrough medicines firstly released on market in 1999 (i.e.: rofecoxib or Vioxx® followed by celeroxib and valdecoxib for Celebrex® and Bextra®) were mostly removed from market in 2005 (Vioxx® and Bextra®) because of severe cardiovascular (CV) adverse events that lead to the deaths of several patients (i.e.: currently still in investigation by the FDA). It seems that the CV risk associated with COX-2 inhibitors represent a “class effect” that includes all similar drugs. As a result, FDA also required that the remaining COX-2 inhibitor product on market, celecoxib (Celebrex®) be considered as an high risk product for chronically ill patients with arthritis for example, that don't have any other treatment alternative, because of GI bleeding problems with other NSAIDs. Of course, as long as they do not have any other underlying CV problems.

(2) Corticosteroids

These agents can reduce temporarily pain and inflammation in patients afflicted with various rheumatic diseases. However corticosteroids are rarely used for long term treatment (i.e.: either oral or injection routes) due to the well-known side-effect profile of these medications that adversely hit badly several systems such as cardiovascular and immunity. Even when corticosteroids are delivered by injection in an affected joint for example (i.e. with expected few adverse effects), the number of injections per joint is limited to four on an annual basis. Therefore corticosteroids are definitely not a first line therapy even in severe pain condition associated with inflammation.

(3) Disease-Modifying Anti-Rheumatic Drugs (DMARDs)

These products are recommended as first line therapy for patients with rheumatoid arthritic that failed to respond to other therapies. DMARDs work by slowing down inflammation and associated pain but these products are responsible to cause severe side-effects that concern treating physicians when they balance risk/benefit of such medications. Typical examples of DMARDs are methotrexate, sulfasalazine, auranofin, gold sodium thiomalate and aurothioglucose, both used by injection.

(4) Biologic Response Modifiers (Biologic)

This is a new class of drugs for treating inflammatory conditions such as rheumatoid arthritis and for preventing disease progression. Biologic work much more quickly than DMARDs. However most of those products are injectable that are responsible to cause severe adverse effects (serious infections, liver damage, birth defects, bone marrow dysplasia, etc) including fatalities. Annual drug cost is also an issue and is estimated between 12,500 $US to 18,000 $US per patient. Four biologics are currently available on market: etanercept (Enbrel®), infliximab (Remicade®), anakinra (Kineret®) and leflonomide (Arava®).

Therefore even if the number of patients with musculo-skeletal problems such as arthritis is on the rise (i.e. 60 millions Americans estimated to be affected with the chronic form of arthritis, by 2020, according to an FDA report), paradoxically, the number of safe drug options to control inflammation associated with pain (i.e.: plus other musculo-skeletal disorders with pain primarily) is declining to almost nothing.

Inflammation can be defined as a local response to cellular injury that initiates the elimination of noxious agents and damaged tissue. It is thus a complex process of physiological and immunological events characterized by capillary dilation, leukocyte infiltration, redness, heat, pain and swelling. Polymorphonuclear neutrophils (hereinafter, “PMNs”) and eosinophils are among the list of important mediators of inflammation and release growth factors, cytokines, prostaglandins, leukotrienes and proteases that exacerbate tissue damage. PMN-derived serine proteases such as elastase and cathepsin G are known pathogenic factors in inflammatory and degenerative diseases that include abnormal tissue catabolism. Although the inflammatory response can be regulated by anti-inflammatory agents such as corticocosteroids, immunosuppressants, non steroidal anti-inflammatory drugs (NSAIDs), COX-2 inhibitors and protease inhibitors, many of these agents have significant side effects. Corticosteroids may induce Cushingoid features, skin thinning, increased susceptibility to infection and suppression of the hypothalamic-pituitary-adrenal axis. Immunosuppressants may induce hypertension and nephrotoxicity.

U.S. Pat. No. 6,696,419 describes compositions and methods for treating inflammation. In particular, it relates to a formulation including a boron containing complex having a tetrahedral boron atom, which is bound to four ligands. The formulation is used to reduce inflammation when administered.

U.S. Patent Application published under No. 20050112118 a method for treating inflammation and inflammatory disorders. The method comprises the step of administering to a patient in need of such treatment a compound capable of interfering with the interaction between a first protein which is PRAK and a second protein which is ERK3.

However, all the previously proposed solutions presented at least some drawbacks. Some of them encompassed some serious secondary effects and some others resulted in relatively costly products. Thus, there is still a need to provide new compounds and compositions for use as an anti-inflammatory agent.

### SUMMARY OF THE INVENTION

In accordance with one aspect of the present invention there is provided compounds of formula (I):

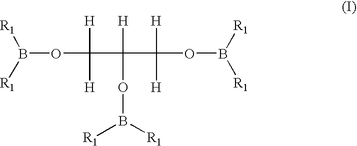

wherein
R₁ is H, a C₁-C₁₂ alkyl, a C₂-C₁₂ alkenyl, a C₂-C₁₂ alkynyl, a C₃-C₈ cycloalkyl, a C₃-C₈ cycloalkenyl, a C₆-C₁₂ aryl, a C₁-C₁₂ heteroaryl group, —OR₂, or each R₁ of a same boron atom are connected together so as to form a 4 to 6 membered ring; and
R₂ is H, a C₁-C₁₂ alkyl, a C₂-C₁₂ alkenyl, a C₂-C₁₂ alkynyl, a C₃-C₈ cycloalkyl, a C₃-C₈ cycloalkenyl, a C₆-C₁₂ aryl, a C₁-C₁₂ heteroaryl or each R₂ of a same boron atom are connected together so as to form a 4 to 6 membered ring,

the alkyl, alkenyl, alkynyl, cycloalkyl, cycloalkenyl, aryl, and heteroaryl groups being unsubstituted or substituted by a hydroxy, a C₁-C₁₂ alkyl, a C₁-C₆ hydroxyalkyl, or a C₁-C₆ alkoxy.

It has been found that the compounds of the present invention represent a very efficient solution for treating inflammation. They thus also represent an advantageous alternative to the compounds of the prior art. In fact, they have been found to be very effective to reduce inflammation, preferably when administered topically on the site of inflammation. These compounds can also be easily prepared at low costs and their synthesis is simple and expedient. Some of these compounds can be rapidly prepared in a single step from commercially available intermediates.

In accordance with another aspect of the present invention there is provided a composition comprising a compound of formula (I), and a pharmaceutically acceptable carrier.

In accordance with another aspect of the present invention there is provided a kit for treating inflammation and/or pain comprising a compound of formula (I), and instructions for using the same.

In accordance with another aspect of the present invention there is provided a kit for treating inflammation and/or pain including a composition comprising a compound of formula (I) and a pharmaceutically acceptable carrier, and instructions for using the same.

In accordance with another aspect of the present invention there is provided a kit for treating musculo-skeletal disorders including a composition comprising a compound of formula (I) and a pharmaceutically acceptable carrier, and instructions for using the same.

In accordance with another aspect of the present invention there is provided a method for treating inflammation and/or pain in a subject in need thereof, comprising administering to the subject an effective amount a compound of formula (I).

In accordance with another aspect of the present invention there is provided a method for treating musculo-skeletal disorders in a subject in need thereof, comprising administering to the subject an effective amount a compound of formula (I).

In accordance with another aspect of the present invention there is provided a method for treating inflammation and/or pain in a subject in need thereof, comprising administering to the subject an effective amount of a composition comprising a compound of formula (I) and a pharmaceutically acceptable carrier.

In accordance with another aspect of the present invention there is provided a method for treating musculo-skeletal disorders in a subject in need thereof, comprising administering to the subject an effective amount of a composition comprising a compound of formula (I) and a pharmaceutically acceptable carrier.

In accordance with another aspect of the present invention there is provided the use of a compound of formula (I) for treating inflammation and/or pain in a subject in need thereof.

In accordance with another aspect of the present invention there is provided the use of a compound of formula (I) for treating musculo-skeletal disorders in a subject in need thereof.

In accordance with another aspect of the present invention there is provided the use of a composition comprising a compound of formula (I) and a pharmaceutically acceptable carrier, for treating inflammation and/or pain in a subject in need thereof.

In accordance with another aspect of the present invention there is provided the use of a composition comprising a compound of formula (I) and a pharmaceutically acceptable carrier, for treating musculo-skeletal disorders in a subject in need thereof.

In accordance with another aspect of the present invention there is provided a process for preparing a compound of formula (I) as previously defined. This process comprises the step of reacting compound of formula (II):

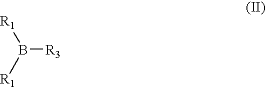

wherein
R₁ and R₂ are as previously defined in claim 1; and
R₃ is —OH, a halogen atom, or —OR₄; and
R₄ is a C₁-C₁₂ alkyl group,

together with glycerol so as to obtain the compound of formula (I).

The term “alkyl” as used herein refers to linear or branched radicals. Examples of such radicals include, but are not limited to, methyl, ethyl, n-propyl, isopropyl, n-butyl, isobutyl, sec-butyl, tert-butyl, pentyl, iso-amyl, hexyl and the like.

The term “alkenyl” as used herein refers to linear or branched radicals having at least one carbon-carbon double bond in a radical. Examples of alkenyl radicals include, but are not limited to, ethenyl, propenyl, allyl, propenyl, butenyl and 4-methylbutenyl. The term “alkenyl” include radicals having “cis” and “trans” orientations, or alternatively, “E” and “Z” orientations.

The term “alkynyl” as used herein refers to linear or branched radicals. Examples of such radicals include, but are not limited to, propargyl, butynyl, and the like.

The term “cycloalkyl” as used herein refers to saturated carbocyclic radicals. Examples of such radicals include cyclopropyl, cyclobutyl, cyclopentyl and cyclohexyl. The term “cycloalky” additionally encompasses spiro systems wherein the cycloalkyl ring has a carbon ring atom in common with the seven-membered heterocyclic ring of the benzothiepene.

The term “cycloalkenyl” as used herein refers to unsaturated carbocyclic radicals having at least one double bond. Cycloalkenyl radicals that are partially unsaturated carbocyclic radicals that contain two double bonds (that may or may not be conjugated) can be called “cycloalkyldienyl”.

The term “aryl” as used herein refers to a carbocyclic aromatic system containing one or more rings wherein such rings may be attached together in a pendent manner or may be fused. The term “aryl” includes, but is not limited to, aromatic radicals such as cyclopentodienyl phenyl, naphthyl, tetrahydronaphthyl, indanyl, biphenyl, and anthracenyl.

The term “heteroaryl” as used herein refers to fused or unfused radicals, preferably 3-10 membered fused or unfused radicals. Preferred examples of heteroaryl radicals include benzofuryl, 2,3-dihydrobenzofuryl, benzothienyl, indolyl, dihydroindolyl, chromanyl, benzopyran, thiochromanyl, benzothiopyran, benzodioxolyl, benzodioxanyl, pyridyl, thienyl, thiazolyl, furyl, and pyrazinyl. More preferred heteroaryl radicals are 5- or 6-membered heteroaryl, containing one or two heteroatoms selected from sulfur, nitrogen and oxygen such as thienyl, furanyl, thiazolyl, imidazolyl, pyrazolyl, isoxazolyl, isothiazolyl, pyridyl, piperidinyl or pyrazinyl. The term “heteroaryl” includes, but is not limited to, a fully unsaturated heterocyclyl. The term “heteroaryl” also includes all positional isomers. In the “heteroaryl” radical, the point of attachment to the molecule of interest can be at the heteroatom or elsewhere within the ring.

The expression “pharmaceutically acceptable carrier” is meant a material that is not biologically or otherwise undesirable, i.e., the material may be incorporated into a pharmaceutical composition administered to a patient without causing any undesirable biological effects or interacting in a deleterious manner with any of the other components of the composition in which it is contained.

The expression “effective amount” as used herein refers to a nontoxic but sufficient amount of the drug or agent to provide the desired effect.

In the compounds of the present invention, R₁ is preferably —OH.

Alternatively, R₁ can be a group of formula —OR₂, wherein the R₂ groups are connected together so as to form a group of formula:

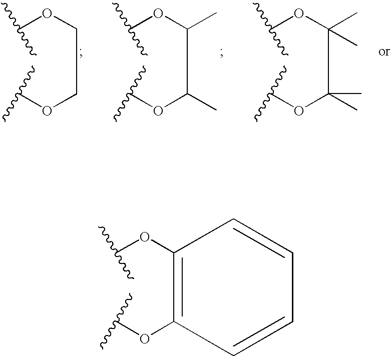

The process of the present invention, can be carried out by reacting together the compound of formula (I) (or metaboric acid) and glycerol and then heating, preferably at a temperature of about 100° C. to about 180° C. Preferably, the process is carried out by a) reacting together the compound of formula (I) and glycerol at a temperature of about 100° C. to about 105° C.; and b) heating the mixture obtained in step (a) at a temperature of about 110° C. to about 180° C. Alternatively, the process can be carried out by: a) heating glycerol at a temperature of about 100° C. to about 105° C. and adding thereto the compound of formula (I) so as to obtain a mixture; and b) heating the mixture at a temperature of about 110° C. to about 180° C.

The composition of the present invention is preferably in a form suitable for administration as following: topical, oral, rectal, inhalation, injection and absorption through mucous membrane. Such a form can be of a cream, a lotion, a solution, a gel, a paste, an emulsion, a foam, an inhalant, an aerosol, a liniment, a syrup, a transdermal patch (electrical or not), a soft melt tablet, a powder, an injectable (subcutaneous, intravenous, intramuscular, intraperitoneal, intracranial and intrathecal) a transdermal infusion, an implant, a liposomal system and a suppository. A cream is particularly preferred. A preferred composition is one comprising a compound of formula (I), wherein R₁ is —OH and a pharmaceutically acceptable carrier.

The compositions can comprise several other ingredients such as petrolatum, lanolin, polyethylene glycols, bee wax, mineral oil, diluents such as water and alcohol, and emulsifiers and stabilizers. Thickening agents may also be present.

Suitable thickeners include those conventionally employed in topical creams such as, for example, monoglycerides and fatty alcohols, fatty acid esters of alcohols having from about 3 to about 16 carbon atoms. Examples of suitable monoglycerides are glyceryl monostearate and glyceryl monopalmitate. Examples of fatty alcohols are cetyl alcohol and stearyl alcohol. Examples of suitable esters are myristyl stearate and cetyl stearate. The monoglyceride also functions as an auxiliary emulsifier. Other emollients or oleaginous material which may be employed include petrolatum, glyceryl monooleate, myristyl alcohol and isopropyl palmitate.

In the compositions of the invention, several other components can be used such as (1) sugars, such as lactose, glucose and sucrose; (2) starches, such as corn starch and potato starch; (3) cellulose, and its derivatives, such as sodium carboxymethyl cellulose, ethyl cellulose and cellulose acetate; (4) powdered tragacanth; (5) malt; (6) gelatin; (7) talc; (8) excipients, such as cocoa butter and suppository waxes; (9) oils, such as peanut oil, cottonseed oil, safflower oil, sesame oil, olive oil, corn oil and soybean oil; (10) glycols, such as propylene glycol; (11) polyols, such as glycerin, sorbitol, mannitol and polyethylene glycol; (12) esters, such as ethyl oleate and ethyl laurate; (13) agar; (14) buffering agents, such as magnesium hydroxide and aluminum hydroxide; (15) alginic acid; (16) pyrogen-free water; (17) isotonic saline; (18) Ringer's solution; (19) ethyl alcohol; (20) phosphate buffer solutions; (21) benzyl alcohol as solvent (22) EDTA (ethylene diamine tetracetic acid) as chelating agent; (23) other non-toxic compatible substances employed in pharmaceutical formulations; and (24) water.

Suitable thickeners can also be used in the compositions of the present invention such as those conventionally employed in topical creams. Examples include but are not limited to beeswax, hard paraffin, monoglycerides and fatty alcohols, fatty acid esters of alcohols having from about 3 to about 16 carbon atoms. Examples of suitable monoglycerides are glyceryl monostearate and glyceryl monopalmitate. Examples of fatty alcohols are cetyl alcohol and stearyl alcohol. Examples of suitable esters are myristyl stearate and cetyl stearate. The monoglyceride also functions as an auxiliary emulsifier. Other emollients or oleaginous material which may be employed include petrolatum, glyceryl monooleate, myristyl alcohol and isopropyl palmitate.

The compositions of the present invention can also comprise triglyceride base such as triethanolamine or a preservative agent such as methylparaben (methyl-4-hydroxybenzoate), propylparaben (propyl-4-hydroxybenzoate) and phenetyl alcohol. They can also comprise a stabilizer such as ethylene glycol palmitostearate.

The compounds, compositions and method of the present invention can be useful for treating various type of inflammation. As example, they can be used for treating articular inflammation, extra-articular inflammation, rheumatoid arthritis, juvenile chronic arthritis, skin inflammation, inflammation of soft tissues; inflammation presents in acute and chronic neurodegenerative disorders such as: stroke, Alzheimer disease, Parkinson disease, multiple sclerosis, amyotrophic lateral sclerosis (ALS or Lou Gehrig disease); AIDS dementia complex (HIV-associated dementia); inflammation presents in vascular disorders such as: myocardial infarction and essential hypertension (secondary to arterial stiffness); and inflammation with infection in cystic fibrosis (lower airway inflammation). They can alternatively be used for treating asthma, rheumatoid arthritis, myositis, Chron's disease, gastritis, colitis, ulcerative colitis, inflammatory bowel disease, proctitis, pelvic inflammatory disease, systemic lupus erythematosus, rhinitis, conjunctivitis, scleritis, chronic inflammatory polyneuropathy, Tertiary Lyme disease, psoriasis, dermatitis, eczema, acne, gingivitis, periodontitis, pruritus, decubitus ulcer, allergic dermatitis, seborrheic dermatitis, mummular dermatitis, actinic keratosis, actinic lentigos, ichthyoses, ichtyposiformis, Darier maladay, palmoplantary keratodermies, leucoplasiesi, eucoplasiformis, lichen, blister, collagen maladies, ultraviolet light damage, rosacea, melasma, comedons, polymorphs, conglobata, infection, sinusitis, dyshidrosis tonsillitis, bronchitis, buccal ulceration, laryngitis, orophoryngeal, mucositisrheumatoid spondylitis, osteoarthritis, gouty arthritis, uveitis, iritis, chronic rhinosinusitis, distal proctitis, gastrointestinal diseases, inflammatory bowel diseases, urogenital diseases, fungal, yeast, bacterial and viral dermatides and wounds.

In accordance with another aspect of the present invention there is provided a process for preparing a compound of formula:

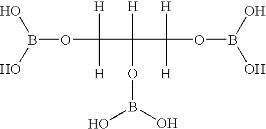

The process comprises the step of reacting together glycerol together with metaboric acid (HBO₂). Such a reaction is preferably carried out at a temperature of about 100° C. to about 180° C.

All references referred herein are hereby incorporated by reference.

### DETAILED DESCRIPTION OF PREFERRED EMBODIMENTS OF THE INVENTION

The present invention will be more readily understood by referring to the following examples which are given to illustrate the invention rather than to limit its scope.

### EXAMPLE 1

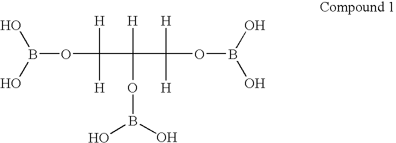

Compound 1 was prepared according to the general following procedure. In a first step, glycerol (OHCH₂CH(OH)CH₂OH) (53.0 g) was added to 100 ml 3-neck reaction flask. Temperature was raised to 92° C. and kept constant for 5 minutes. Boric acid (B(OH)₃) (40.0 g) was then added to the flask and a temperature of 100-105° C. was maintained for 30 minutes. In a second step, temperature was raised rapidly, over a period of less than 5 minutes, to about 120-125° C. and maintained for 130 minutes. Water generated during the reaction was vacuumed and transferred into a 20 ml volumetric separator, and weighted out on a balance (to 0.01 g). Approximately 25% of water (≈23 g) was collected at the end of this procedure. Finally, in a third step, temperature was increased rapidly (in less than 5 minutes) to 130-135° C. and more water was vacuumed, transferred and weighted out until an additional 5% of total initial weight was collected, over a 10-15 minutes time period. At this point, the maximum water collected from second and third steps preferably does not exceed 32%, so as to minimize the increase of viscosity of the mixture, thereby avoiding the product to have a semi-solid state.

The obtained Compound 1 was transparent with a faint yellowish color. It was then cooled to 90° C. and poured into glass containers. When temperature reached room temperature 20-24° C., containers were weighted and closed tightly since Compound 1 is hygroscopic. Yield of product was approximately 60%.

The mass spectroscopy analysis (electrospray/scanning) using a Micromass quattra ll triple quadrupole mass spectrometer with a GC and HPLC interface, confirmed the previously illustrated formula for Compound 1. Analysis of Compound 1 was done by mass spectroscopy, positive mode, preparation of samples in 2% acetonitrile-98% methanol. Scanning between 100 to 760 atomic units do not indicate the presence of polymer, chain, dimer, trimer, etc. The product observed was the following: B₃C₃H₁₁O₉ (223.5 g per mole). The fragmentation in daughter mode of the major ion indicates that it is conformed to the proposed structure, which correlated the observed fragmentation. The purity of the obtained product was>98 % (confirmed by 500 MHz ¹H NMR analysis) and the solubility in water was at maximum 7% w/w, yielding a clear colorless solution.

Compound 1 has also been prepared using another process. In fact, in this case metaboric acid (HBO₂) was used instead of boric acid. Metaboric acid and glycerol were thus reacted together as follows. In a first step, glycerol (OHCH₂CH(OH)CH₂OH) (23.2 g) was added to 50 mL 3-neck reaction flask. Temperature was raised to 100° C. and kept constant for 5 minutes. Metaboric acid (HBO₂) (17.5 g) was then added to the flask and a temperature of 105-110° C. was maintained for 15 minutes. In a second step, temperature was raised rapidly, over a period of 5 minutes, to about 135-140° C. and maintained for 60 minutes. Water generated during the reaction, was vacuumed and transferred into a 10 mL volumetric separator and weighted out on a balance (to 0.01 g). Approximately 15% of water (≈6.1 g) was collected at the end of this procedure. Finally, in a third step, temperature was increased over a period of 10 minutes to 170-180° C., and more water was vacuumed, transferred and weighted out until an additional 2% of total initial weight was collected over a 10-15 minutes time period. At this point, the maximum water collected from the second and third steps preferably does not exceed 18% so as to minimize the increase of viscosity of the mixture, thereby avoiding the product to have a semi-solid state.

The obtained Compound 1 was transparent with a faint yellowish color. It was then cooled to 90° C. and poured into glass containers. When temperature reached room temperature (about 20-24° C.), containers were weighted and closed tightly since Compound 1 was hygroscopic. Yield of product was approximately 75%.

An analysis of Compound 1, prepared by using metaboric acid and glycerol, was conducted under the same condition as for Compound 1 with boric acid and glycerol. Scanning between 100 to 760 atomic units revealed that no polymers, chains, dimers, or trimers etc. were present. The product observed was the following: B₃C₃H₁₁O₉ (223.5 g per mole). The fragmentation in daughter mode of the major indicates that is conformed to the previously illustrated formula for Compound 1. When compared to Compound 1 prepared from boric acid and glycerol, the purity and solubility of the obtained product were similar i.e. a purity of ≈98% with solubility in water at maximum of 7% w/w, yielding a colorless solution.

### EXAMPLE 2

Compositions 1, 2 and 3

Several compositions were prepared by using, as active ingredient or anti-inflammatory agent, Compound 1. The general procedure for preparing Compositions 1 to 3 is the following. In each case three intermediate mixtures i.e. mixtures A, B and C have been prepared separately, and then these mixtures have been combined together so as to obtain Compositions 1 to 3. These compositions, which are in the forms of creams, are as follows.

Composition 1
Mixture A:

| | |
|---|---|
| 1. Polyethylene glycol palmitostearate | 4.00% |
| 2. Capric triglyceride | 2.00% |
| 3. Cetyl alcohol | 4.20% |
| 4. Stearic acid | 6.00% |
| 5. Benzyl alcohol | 3.20% |
| 6. Propylene glycol stearate | 2.00% |
| 7. Beeswax white | 7.00% |
| Total: | 28.40% |

Mixture B:

| | |
|---|---|
| 1. Propylene glycol | 1.50% |
| 2. Methylparaben | 0.20% |
| 3. Propylparaben | 0.03% |
| Total: | 1.73% |

Mixture C:

| | |
|---|---|
| 1. Triethanolamine | 6.00% |
| 2. Sorbitol | 6.00% |
| 3. EDTA | 0.10% |
| 4. Compound I | 7.00% |
| 5. Water, Qs | 50.77% |
| Total: | 69.87% |
| Total: A + B + C | 100.00% |

Composition 2
Mixture A:

| | |
|---|---|
| 1. Polyethylene glycol palmitostearate | 4.00% |
| 2. Capric triglyceride | 2.00% |
| 3. Cetyl alcohol | 3.50% |
| 4. Stearic acid | 7.00% |
| 5. Benzyl alcohol | 3.20% |
| 6. Polyethylene glycol (PEG) | 4.00% |
| 7. Phenetyl alcohol | 2.10% |
| 8. Sorbitan monostearate | 0.50% |
| 9. Beeswax white | 6.00% |
| Total: | 32.30% |

Mixture B:

| | |
|---|---|
| 1. Propylene glycol | 1.50% |
| 2. Methylparaben | 0.20% |
| 3. Propylparaben | 0.03% |
| Total: | 1.73% |

Mixture C:

| | |
|---|---|
| 1. Triethanolamine | 7.00% |
| 2. Sorbitol | 4.00% |
| 3. EDTA | 0.10% |
| 4. Compound I | 7.00% |
| 5. Water, Qs | 47.87% |
| Total: | 65.97% |
| Total: A + B + C | 100.00% |

Composition 3
Mixture A:

| | |
|---|---|
| 1. Polyethylene glycol palmitostearate | 3.00% |
| 2. Capric triglyceride | 2.00% |
| 3. Cetyl alcohol | 3.50% |
| 4. Stearic acid | 6.00% |
| 5. Benzyl alcohol | 3.20% |
| 6. Polyethylene glycol (PEG) | 5.00% |
| 7. Sorbitan monostearate | 1.00% |
| 8. Beeswax white | 7.00% |
| Total: | 30.70% |

Mixture B:

| | |
|---|---|
| 1. Propylene glycol | 1.50% |
| 2. Methylparaben | 0.20% |
| 3. Propylparaben | 0.03% |
| Total: | 1.73% |

Mixture C:

| | |
|---|---|
| 1. Triethanolamine | 6.00% |
| 2. Sorbitol | 6.00% |
| 3. EDTA | 0.10% |
| 4. Diethyleneglycol monoethyl ether | 4.00% |
| 5. Compound I | 7.00% |
| 6. Water, Qs | 44.47% |
| Total: | 67.57% |
| Total: A + B + C | 100.00% |

### EXAMPLE 3

Tests on Various Subjects using Compound 1

Compound 1, and more particularly Composition 1, was tested on several subjects so as to verify its activity as anti-inflammatory agent and/or analgesic. As it can be seen from Table 1, test subjects having various inflammations or pain have been treated with Composition 1. In each case, a small amount of Composition 1, in the form of a cream, was applied to inflammated skin area by means of a short gentle rub. As demonstrated in Table 1, a complete disappearance of pain and/or inflammation in test subjects was observed.

TABLE 1
Use of Compound 1 for Treating Pain and/or Inflammation

| | | | | | | Pain Intensity (a) | | | | | |
|---|---|---|---|---|---|---|---|---|---|---|---|
| | | | | | | | | Time to | | | |
| Volunteer/ | | | | Reason(s) | | | | Pain | Relapse | | Pain Condition |
| Patient | Age | Weight | | for Inflam- | Localization | Before | After | Relief | of Pain | Number of | After Last |
| Code | (years) | (Kg) | Sex | mation & Pain | of Pain | Application | Application | (hrs) | (Y/N) | Applications | Application |
| D-123-S | 57 | 75 | F | Injury | Leg | ++ | + | 0.5 | Y | 3 | CD |
| D-633-J | 64 | 57 | F | Lower back pain, | Lower back, | ++ | 0 | 0.5 | N | 1 | CD* |
| | | | | Musculoskeletal | central | | | | | | |
| D-321-J | 39 | 55 | F | Fibromyalgia | Hands | +++ | 0 | 0.5 | N | 1 | CD* |
| D-457-D | 41 | 64 | F | Fibromyalgia | Hands & feet | ++ | 0 | 0.5 | N | 1 | CD* |
| D-942-L | 54 | 58 | F | Injury | Leg | +++ | ++ | 8.0 | Y | 3 | CD |
| D-701-M | 57 | 84 | M | Arthritis | Wrists | ++ | 0 | 0.5 | Y | 3 | CD |

All data were provided under testimony of all volunteers.

The Compound 1 effect is higher than medications taken in the past to treat the same chronic afflictions (i.e.: acetaminophen/Tylenol®, acetaminophen-codeine/Empracet® or acetylsalicylic acid/Aspirin®). Moreover Empracet® and Aspirin® were responsible for severe gastric burning sensation that prompted discontinuation of products.

The various terms and expressions used in Table 1 are as follows:

F: female

M: male
a) Pain intensity rating:
   No pain: 0
   Mild pain: +
   Moderate pain: ++
   Severe pain: +++ (i.e.: interference with sleep and/or day's activities).
b) Pain condition after the last application of Compound 1.
   CD: complete disappearance of pain.
   RP: residual pain (i.e.: equivalent to mild pain intensity).

Compound 1 reduced pain intensity for all volunteers. Four subjects out of six experienced a total disappearance of pain, 30 minutes after application of the cream containing Compound 1. There was a complete disappearance of pain for all subjects including those (three out of six) who required a maximum of three applications of Compound 1.

In view of the results presented in Table 1, it can be said that Compound 1 is quite efficient as an analgesic and anti-inflammatory agent.

In fact, two of the subjects were afflicted with an injury to a leg and a complete disappearance of pain was observed within three days. Before the treatment, other subjects have been suffering from disease conditions such as lower back pain, fibromyalgia and arthritis in their chronic forms for at least three years. The pain was severe for one subject and moderate for three others with chronic disease condition. Following to the treatment using a cream containing Compound 1, for all subjects including the one with lower back pain, a complete relief of the pain was observed in approximately 30 minutes after the application. Moreover, only one out of four subjects had required additional applications (for a total of three) since pain relapsed approximately 12 hours later for the afflicted subject.

There was an evidence of inflammation for all four subjects with chronic state of disease; stiffness was common for all, whereas swelling at joints was present for subjects with fibromyalgia and arthritis. Another sign of inflammation, tenderness, was present on hands of one of the subject afflicted with fibromyalgia (subject code D-457-D). Following application of Compound 1, all four subjects with chronic diseases had a reduced sensation of stiffness within two hours and a complete loss of stiffness within four four hours. Loss of swelling at joints and tenderness sensation disappeared in approximately the same time-frames as reported earlier for stiffness.

### EXAMPLE 4

In order to evaluate Compound 1, a cytotoxicity assay was carried out and the results of this assay are as follows.

TABLE 2
In Vitro Cytotoxicity Evaluation of Compound 1 in a
Dose Range Assay with White Blood Cells (Monocytes)

| | Product Concentration | | Cell Count | % Inhibition |
|---|---|---|---|---|
| Product | μM | mg | (a) ×10⁶ | (b) |
| Compound 1 | 0 | 0 | 3.2860 | 0 |
| Compound 1 | 15.5 | 3.47 | 3.4450 | 0 |
| Compound 1 | 155.0 | 34.72 | 3.9235 | 0 |
| Compound 1 | 1550.0 | 347.20 | 1.8675 | 43.17 |
| Compound 1 | 15500.0 | 3472.00 | 1.8090 | 44.95 |

(a) Cells: Mononuclear white blood cells also called monocytes. Cell line is CBMC, for cord blood mononuclear cells. Cell counts were performed 7 days contact and compared with blank controls. Cell count value for each test represents an average of a duplicate cell counting.
(b) % Inhibition (on cell viability): Cell death was assessed microscopically by the technique of trypan blue dye exclusion.

As shown in Table 2, Compound 1 does not have any effect on cell viability at 155 μM, which represents approximatively an in vivo intake of 2 grams. A 43% inhibition in cell number is obtained with 1550 μM; therefore indicating that Compound 1 is a safe product to utilize.

The above-mentionned results presented by way of examples only clearly demonstrate that the compounds of the present invention, and more particularly compound 1, is very efficient as an anti-inflammatory agent or analgesic. It was also demonstrated that such compounds, that can be produced at low costs, can also be very useful for being used in the methods defined in the present invention. Moreover, it was shown that these compounds are safe.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A compound of formula (I): 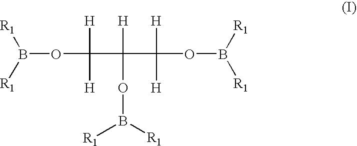
wherein
R₁ is H, a C₁-C₁₂ alkyl, a C₂-C₁₂ alkenyl, a C₂-C₁₂ alkynyl, a C₃-C₈ cycloalkyl, a C₃-C₈ cycloalkenyl, a C₆-Cl₂ aryl, a C₁-C₁₂ heteroaryl group, —OR₂, or each R₁ of a same boron atom are connected together so as to form a 4 to 6 membered ring; and
R₂ is H, a C₁-C₁₂ alkyl, a C₂-C₁₂ alkenyl, a C₂-C₁₂ alkynyl, a C₃-C₈ cycloalkyl, a C₃-C₈ cycloalkenyl, a C₆-C₁₂ aryl, a C₁-C₁₂ heteroaryl or each R₂ of a same boron atom are connected together so as to form a 4 to 6 membered ring,
said alkyl, alkenyl, alkynyl, cycloalkyl, cycloalkenyl, aryl, and heteroaryl groups being unsubstituted or substituted by a hydroxy, a C₁-C₁₂ alkyl, a C₁-C₆ hydroxyalkyl, or a C₁-C₆ alkoxy.

2. The compound of claim 1, wherein R₁ is —OH.

3. The compound of claim 1, wherein R₁ is a group of formula —OR₂, and wherein said R₂ of a same boron atom are connected together so as to form a group of formula:

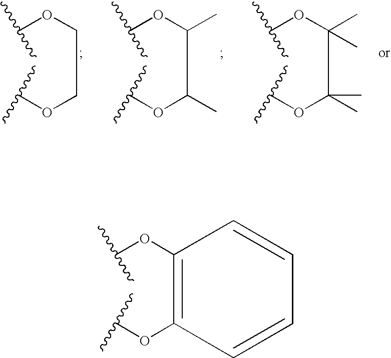

4. A composition comprising a compound as defined in claim 1, and a pharmaceutically acceptable carrier.

5. The composition of claim 4, in a form suitable for topical administration, oral administration, parenteral administration, rectal administration, inhalation or absorption through mucous membrane.

6. A composition comprising a compound as defined in claim 2, and a pharmaceutically acceptable carrier.

7. The composition of claim 6, in a form suitable for topical administration.

8. The composition of claim 6, wherein the carrier is a cream, a lotion, a solution, a gel, a paste, an emulsion, a foam, an inhalant, an aerosol, a liniment, a syrup, a transdermal patch, a soft melt tablet, a powder, an injectable, a transdermal infusion, an implant, a liposomal system or a suppository.

9. A kit for treating inflammation, pain or musculo-skeletal disorders comprising a composition as defined in claim 6, and instructions for using the same.

10. A method for treating inflammation and/or pain in a subject in need thereof, comprising administering to the subject an effective amount of a compound as defined in claim 1.

11. A method for treating inflammation and/or pain in a subject in need thereof, comprising administering to the subject an effective amount of a compound as defined in claim 2.

12. A method for treating inflammation and/or pain in a subject in need thereof, comprising administering to the subject an effective amount of a composition as defined in claim 6.

13. The method of claim 11, wherein said inflammation is articular inflammation, extra-articular inflammation, rheumatoid arthritis, juvenile chronic arthritis, skin inflammation or inflammation of soft tissues, inflammation presents in acute and chronic neurodegenerative disorders, inflammation presents in vascular disorders or inflammation associated with infection in cystic fibrosis.

14. The method of claim 11, wherein said inflammation is selected from the group consisting of acne; eczema; gingivitis; psoriasis; pruritus; decubitus ulcer; allergic dermatitis: seborrheic dermatitis; mummular dermatitis; actinic keratosis; actinic lentigos; ichthyoses; ichtyposiformis; Darier maladay; palmoplantary keratodermies; leucoplasies; leucoplasiformis; lichen; blisters; collagen maladies; ultraviolet light damage; rosacea; melasma; comedons; polymorphs; conglobata; infection; sinusitis; dyshidrosis tonsillitis; buccal ulceration; gastrointestinal diseases; inflammatory bowel diseases; urogenital diseases; fungal, yeast, bacterial and viral dermatides, and wounds.

15. The method of claim 11, wherein said compound is topically administered to the site of inflammation.

16. A process for preparing a compound of formula (I) as defined in claim 1, said process comprising the step of reacting compound of formula (II): 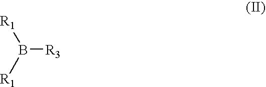
wherein
R₁ and R₂ are as previously defined in claim 1; and
R₃ is —OH, a halogen atom, or —OR₄; and
R₄ is a C₁-C₁₂ alkyl group,
together with glycerol so as to obtain said compound of formula (I).

17. The process of claim 16, wherein said compound of formula (I) and glycerol are reacted together at a temperature of about 100° C. to about 180° C.

18. The process of claim 16, wherein said compound of formula (I) and glycerol are reacted together by:
a) reacting together said compound of formula (I) and glycerol at a temperature of about 100° C. to about 105° C.; and
b) heating the mixture obtained in step (a) at a temperature of about 110° C. to about 180° C.

19. The process of claim 16, wherein said compound of formula (I) and glycerol are reacted together by:
a) heating glycerol at a temperature of about 100° C. to about 105° C. and adding thereto said compound of formula (I) so as to obtain a mixture; and
b) heating said mixture at a temperature of about 110° C. to about 180° C.

20. The process of claim 16, wherein each of said R₁ and R₃ are —OH.

21. A process for preparing a compound of formula: 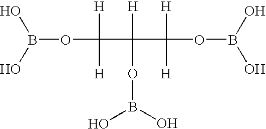
said process comprising the step of reacting together glycerol and boric acid.

22. A process for preparing a compound of formula: 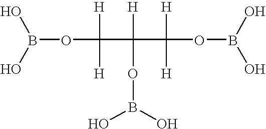
said process comprising the step of reacting together glycerol and metaboric acid.
